(19) United States
(12) Patent Application Publication
(10) Pub. No.: US 2023/0047409 A1
(43) Pub. Date: Feb. 16, 2023

(54) DEVICES AND METHODS FOR PARALLEL PROVISIONING OF NODE NETWORKS

(71) Applicant: STMicroelectronics International N.V., Geneva (CH)

(72) Inventors: Kamaldeep Bansal, Bathinda (IN); Alok Kumar Mittal, Noida (IN); Jitendra Jain, Firozabad (IN)

(21) Appl. No.: 17/401,702

(22) Filed: Aug. 13, 2021

(51) Int. Cl. H04L 12/24; H04W 4/80

(52) U.S. Cl. CPC H04L 41/0806; H04W 4/80; H04W 84/18

(57) ABSTRACT

A method to provision a node network including provisioning a first generation of nodes by a root node; and provisioning a second generation of nodes by the first generation of nodes. Wherein at least one node from the first generation of nodes or the second generation of nodes is provisioned simultaneously with at least one other node from the first generation of nodes or the second generation of nodes.

### TECHNICAL FIELD

The present invention relates generally to systems and methods for parallel provisioning a node network.

### BACKGROUND

Generally, node networks must undergo a burdensome initiation process. Nodes are provisioned individually into a network one at a time. The process can be time consuming and involve onerous human intervention. A need exists for speedier provisioning of node networks.

### SUMMARY

In accordance with an embodiment, a method to provision a node network includes provisioning a first node by a root node; provisioning a second node by the root node; and simultaneously provisioning a first child node of the first node by first node and a first child node of the second node by the second node.

In accordance with an embodiment, a method to provision a node network includes provisioning a first generation of nodes by a root node; and provisioning a second generation of nodes by the first generation of nodes, at least one node from the first generation of nodes or the second generation of nodes being provisioned simultaneously with at least one other node from the first generation of nodes or the second generation of nodes.

A node of a node network, the node including a processing circuit; and a non-transitory computer readable storage medium storing a program for execution by the processing circuit that causes the node to provision a first child node into the node network and allocate a first set of addresses from a group of available addresses to the first child node and descendants of the first child node, and provision a second child node into the node network and allocate a second set of addresses from the group of available addresses to the second child node and descendants of the second child node, the first set of addresses and the second set of addresses being disjoint.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts a node network 100;

FIG. 2 depicts provisioning of a new node into a new node network according to a known step-by-step method;

FIG. 3 depicts provisioning of a second new node into a new node network according to a known step-by-step method;

FIG. 4 depicts a node network with all devices within a communication range of a root node being provisioned of a known provisioning method;

FIG. 5 depicts the provisioning an additional node into a node network after relocating a root node of a known method;

FIG. 6 depicts provisioning of a first node into a node network in accordance with parallel provisioning of an embodiment;

FIG. 7 depicts simultaneous provisioning of second and third nodes into a node network in accordance with parallel provisioning of an embodiment;

FIG. 8 depicts simultaneous provisioning of four additional nodes into a node network in accordance with parallel provisioning of an embodiment;

FIG. 9 depicts simultaneous provisioning of eight additional nodes into a node network in accordance with parallel provisioning of an embodiment;

FIG. 10 depicts generational relationships of the nodes of a node network of an embodiment;

FIG. 11 depicts a node of a node network of an embodiment;

FIG. 12 illustrates a method to provision a node network in accordance with an embodiment; and

FIG. 13 illustrates a method to provision a node network in accordance with an embodiment.

### DETAILED DESCRIPTION OF ILLUSTRATIVE EMBODIMENTS

Node networks are becoming increasingly popular as Internet of Things devices proliferate. More and more homes, parks, buildings, mall, shopping center, ship, backyard and other venues utilize node networks. The nodes of a node network may comprise a wide variety of lights, sensors, displays, equipment, machinery and appliances.

Once part of a node network, the nodes may communicate with each other by relaying messages from node to node. Data can travel along multiple pathways between any two nodes along routes from any of the other nodes in the network. This can reduce the reliance of the system on any central routing unit or units. Plus, the presence of nodes that can generate and receive signals inside a mall, shopping center or other facility allows signals to reach areas with otherwise limited accessibility. It, also, is not necessary to have such a network connected to outside systems. In other words, node networks can be self-contained, which can be desirable for security purposes.

One example of node networks is provided by Bluetooth® Mesh networking, which is a wireless standard. One application for Bluetooth® Mesh networks is in smart buildings. Bluetooth® Mesh features many to many node connectivity where all nodes are reachable from any other node once part of the network. A Bluetooth® Mesh controlled smart building may have hundreds or thousands of mesh nodes catering to different applications such as smart lights (lights in corridors, wash rooms, shops, supermarkets), sensor nodes (temperature sensors, environmental sensors) smart switches, HVAC controls, smart plugs, smart regulators, and emergency nodes. Other equipment and appliances like coffee makers, crock pots, blenders, televisions, monitors and virtually any other electronic device may be a Bluetooth® Mesh enabled node. Bluetooth® Mesh has multi-layer and multi-application configurable security levels to address different scenarios and known security challenges. Bluetooth® Mesh provides flexibility to users, which makes it a leading choice for smart home/smart building applications where high data throughput is not necessarily a priority. Bluetooth® Mesh is gaining popularity around the world and expected to reach billions of nodes.

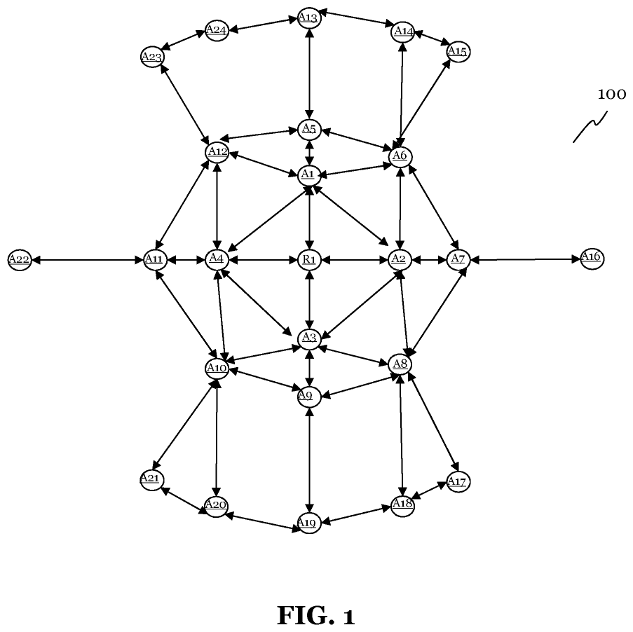

FIG. 1 is a depiction of a node network 100.

The node network 100 includes a plurality of nodes. FIG. 1 illustrates a root node R1 and a first node A1 through a twenty-fourth node A24. The process for adding a new node to a network is known as provisioning. Unprovisioned devices are not part of the network and cannot take advantage of the networks capabilities. New devices may be added to expand a node network, replaces existing nodes, or during the initial configuration of the network. In known methods, the nodes of a new network are provisioned into the network one at a time.

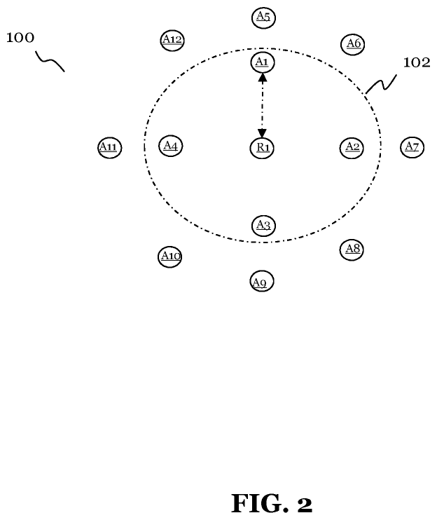

FIG. 2 depicts provisioning of a new node into a new node network according to a known step-by-step method.

A root node R1 of the node network wo may be configured as a provisioning node. The root node may or may not provision itself because it establishes the parameters of the node network wo. The root node R1 has a communication range 102. The root node R1 may detect beacons emitted from unprovisioned devices within the communication range 102 of the device. A first node A1 inside the communication range may emit a beacon that is detected by the root node R1. After detecting the beacon, the root node R1 may initiate the provisioning process. Provisioning is represented by the dashed two-headed arrow between the root node R1 and the first node A1. Once the provisioning process is complete the first node A1 will become part of the node network 100. The root node R1 is free to detect a beacon from a second node A2 located within its range.

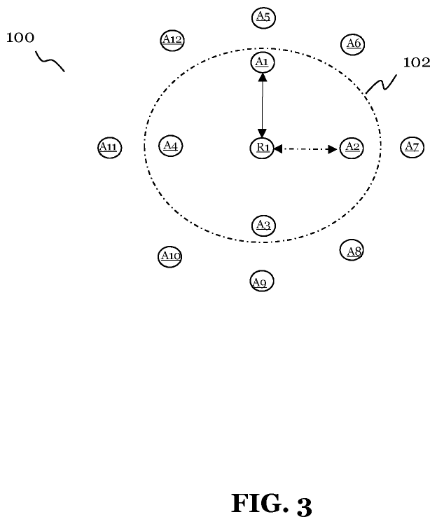

FIG. 3 depicts provisioning of a second new node into a new node network according to a known step-by-step method.

At this point in the provisioning process for the node network 100, the node network 100 includes only the root node R1 and the first node A1. The solid double-headed arrow connecting the root node R1 to the first node A1 symbolizes connection to the node network 100. The root node R1 can detect a beacon from the second node A2 and initiate provisioning of the second node A2 into the node network 100, again represented by the dashed double-headed arrow.

After completion of the provisioning process for the second node A2, the second node A2 becomes part of the node network 100. As part of the same node network 100, the second node A2 and the first node A1 can then communicate directly with each other and any other nodes of the network within their respective communication ranges.

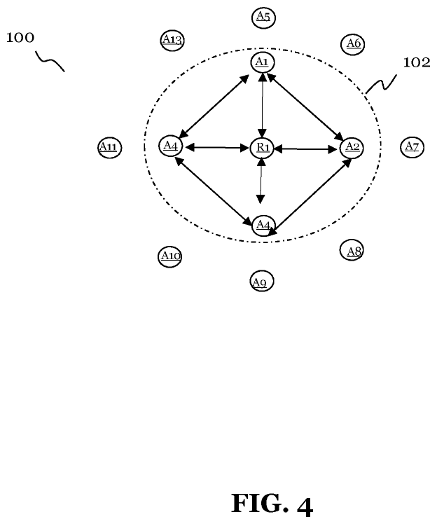

FIG. 4 depicts a node network with all devices within a communication range of a root node being provisioned of a known provisioning method.

Once all the nodes within range of the root node R1 have been provisioned, the first node A1 is moved to provision additional nodes. As depicted in FIG. 4, all nodes within the communication range 102 of the root node R1 are provisioned into the node network 100. To continue to add nodes to the node network 100 the root node R1 is moved.

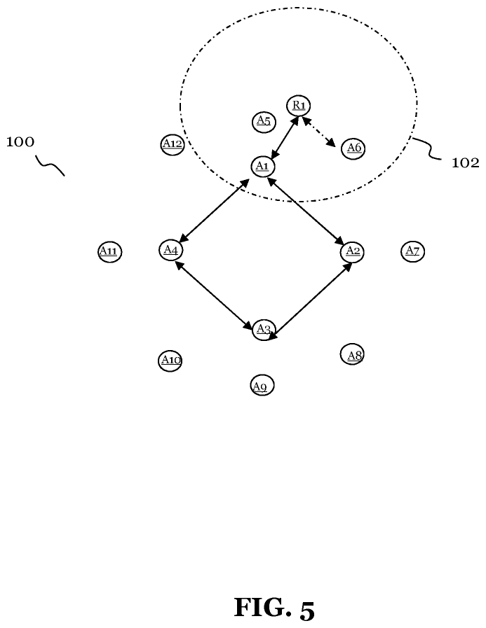

FIG. 5 depicts the provisioning an additional node into a node network after relocating a root node of a known method.

After the root node R1 has been relocated additional unprovisioned devices may be in the communication range 102 of the root node R1. The root node R1 detects a beacon from the unprovisioned device and begins to provision the device into the network. The process for provisioning new nodes is again depicted by a double-headed dashed arrow. Unprovisioned devices within the communication range 102 of the root node R1 are provisioned one-by-one into the node network 100. The root node R1 may need to be relocated numerous times provision all the devices into the node network.

Provisioning nodes one-by-one into the node network wo can be very time consuming. Node networks are becoming increasingly popular and can include hundreds, thousands or tens of thousands of nodes. The known methods of provisioning each node into a network one-by-one, either by a root node or by previously-provisioned nodes that are also configured to provision additional nodes, can become extremely burdensome as more and more nodes are added. This can require manual setup each time a new node is added to a network after the original network provisioning. One-by-one provisioning also makes it easy to miss unprovisioned devices so some devices may be undesirably left out of the network.

A faster more efficient process for provisioning a network may be achieved by provisioning multiple nodes of a node network in parallel. For example, a root node may set the network parameters. The root node may provision a first node. The first node may also be configured to provision nodes into a node network and the root node and the first node may simultaneously provision additional nodes into the node network. As more nodes are provisioned into the network, the network's capacity to provision new nodes will also increase. And, the communication ranges for the nodes in combination may be greater than the range of just the root node. Parallel provisioning can continue until every unprovisioned device is provisioned within a range of any of node of a node network.

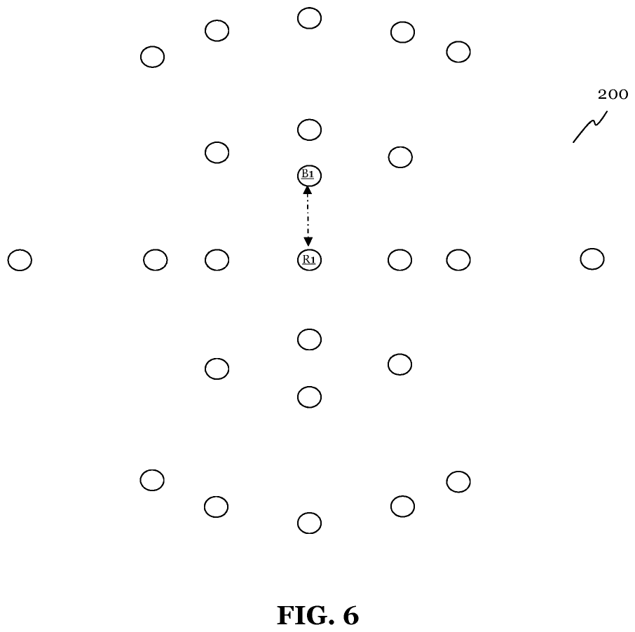

FIG. 6 depicts provisioning of a first node into a node network in accordance with parallel provisioning of an embodiment.

The nodes of a node network 200 may be dispersed throughout a physical space such as the interior of a building, warehouse, mall, stadium home, office or other structure. A node network 200 can also span multiples spaces such as indoor-outdoor arrangement. For example, a node network 200 can be located on a street, a town, a park, campus, on a ship, or a backyard. In short, a node network 200 may be located in any place where the nodes may be placed.

The nodes of the node network can also take different forms. They may be smart devices like smart switches, or smart appliances. Nodes can also be sensors, cameras, mobile devices, wearable buttons or tokens, or dedicated nodes. Virtually any electronic device can also be configured to be a node of a node network 200. A single device may even comprise more than one node.

In embodiments, the node network 200 may comprise a variety of different types of nodes. Some of the plurality of nodes of the node network 200 may be switches, some of the plurality of nodes of the node network 200 may be lights, some of the plurality of nodes of the node network 200 may be sensors, and some of the plurality of nodes of the node network 200 may be smart appliances. The node network 200 may comprise any combination of different types of nodes. In some embodiments, nodes of the node network 200 are configured for node to node communication.

The node network 200 may comprise a mesh network. Each node in the node network 200 may be configured to relay transmissions to and from the other nodes in the node network 200 that are in range of the transmitting nodes. In this way, data signals may be relayed from any one of the nodes in the network to any, or all, the other nodes in the node network even if they are out of range of direct communication. For example, referring back to FIG. 1 for illustration, a message may be delivered from the twenty-fourth node A24 of the node network 100 to an eighteenth A18 node by relaying the message through a series of nodes located between the twenty-fourth node A24 and the eighteenth node A18. Each relay can be referred to as a hop.

Messages and, or, signals, may be relayed in the node network 200 by a flooding or managed flooding. In various embodiments, the node network 200 may be configured for many to many communications between the nodes of the node network 200. Data from any node in the node network 200 may also be accessed from any other point in the network. In some embodiments, the node network 200 comprises a Bluetooth® Mesh network. The nodes of the node network 200 may comprise Bluetooth® Low Energy smart devices.

The nodes of the node network 200 may also be addressable so that data transmissions can be relayed through the node network 200 to them. For example, again referring back to FIG. 1 for illustration, in an addressable network a data transmission may be addressed to a twenty-fourth node A24 of the node network 100. By way of example, the twenty-fourth node A24 may comprise a smart locking device. A message relayed through the node network 100 may lock the twenty-fourth node A24. The locking message may be addressed to the twenty-fourth node A24 individually so that only the twenty-fourth node A24 will implement the direction to lock even though the message has been relayed from node to node to reach the twenty-fourth node A24.

The process of provisioning new nodes into a node network 200 may vary in different types of networks. Provisioning may comprise an initial beaconing by an unprovisioned device. This may occur when a device is powered up for the first time or may be initiated by a command. For example, a switch or button on the unprovisioned device may initiate a beaconing.

A provisioning node of the node network 200 may detect the provisioning beacon emitted by the unprovisioned device and initiate an information exchange with the unprovisioned device. The information exchange may include an exchange of public keys, private keys and authentication procedures. The provisioning process may also include assigning an address to the new node so messages can be directed to the new node through the network. For illustrative purposes, unprovisioned nodes are not labeled in FIG. 6. They are illustrated by unfilled circles.

The original node in a node network 200, may be called the root node R1. A root node R1 may establish the network parameters. The root node R1 may also be assigned an address.

After the network is initiated a first node B1 may initiate a beacon. The root node R1 may detect the beacon from the first node B1 and provision the first node B1 (the communication range of the root node R1 is not depicted in FIG. 6.) The first node B1 may also be configured to provision additional nodes into the node network. And, once the first node B1 is provisioned into the network, both the first node B1 and the root node R1 may then provision additional nodes into the node network 200. This provisioning of additional nodes may occur simultaneously.

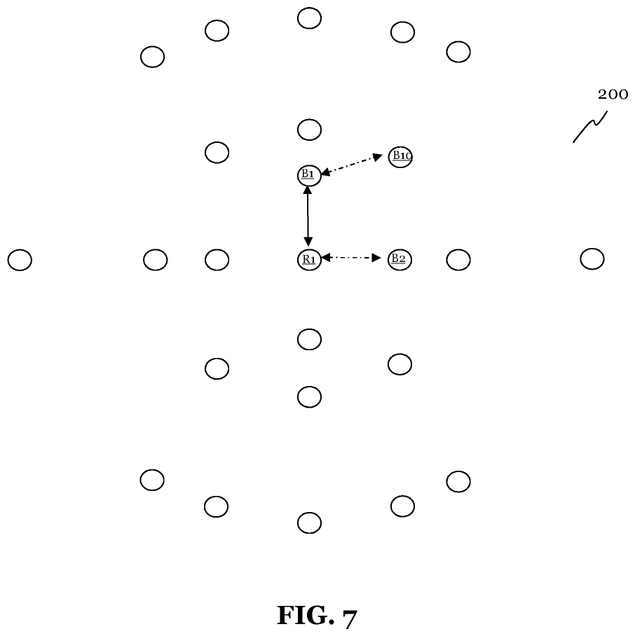

FIG. 7 depicts simultaneous provisioning of second and third nodes into a node network in accordance with parallel provisioning of an embodiment.

The first node B1 may detect a beacon and provision a node within its communication range at the same time the root node R1 detects and provisions another node. As symbolized in FIG. 7 by dashed double-headed arrows, the second node B2 is being provisioned by the root node while a node B10 is being provisioned by the first node. After the second node B2 is provisioned, the second node B2 may also be configured to provision additional nodes into the node network. In various embodiments, every node of the node network 200 may be configured to provision additional nodes.

As will be appreciated, parallel provisioning will allow the node network 200 to be fully provisioned much more quickly. New nodes added to the node network 200 will add to the capacity of the network to provision new nodes. This will allow provisioning to progress exponentially rather than arithmetically.

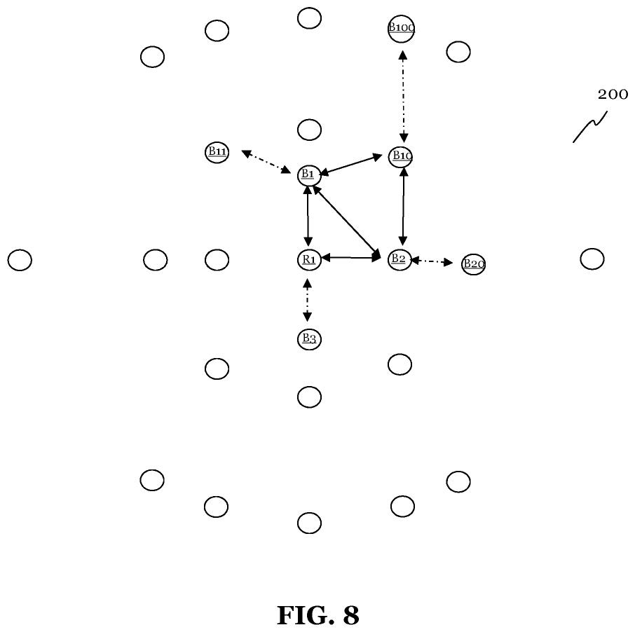

FIG. 8 depicts simultaneous provisioning of four additional nodes into a node network in accordance with parallel provisioning of an embodiment.

In FIG. 8, the root node R1, the first node B1, the second node B2, and node B10 have all been provisioned into the network. This is, again, symbolized by solid double-headed arrow connecting the nodes to the other nodes of the node network 200 within communication range of the nodes. The root node R1, the first node B1, the second node B2, and node B10 are also provisioning additional nodes into the network (as illustrated by dashed double-headed arrows). The root node R1 is provisioning the third node B3 into the node network. The first node B1 is provisioning the node B11 into the node network 200. The second node B2 is provisioning node B20 into the node network 200 and the node B10 is provisioning node B100 into the node network 200. With 4 nodes in the network as many as four additional nodes may be simultaneously provisioned into the node network 200.

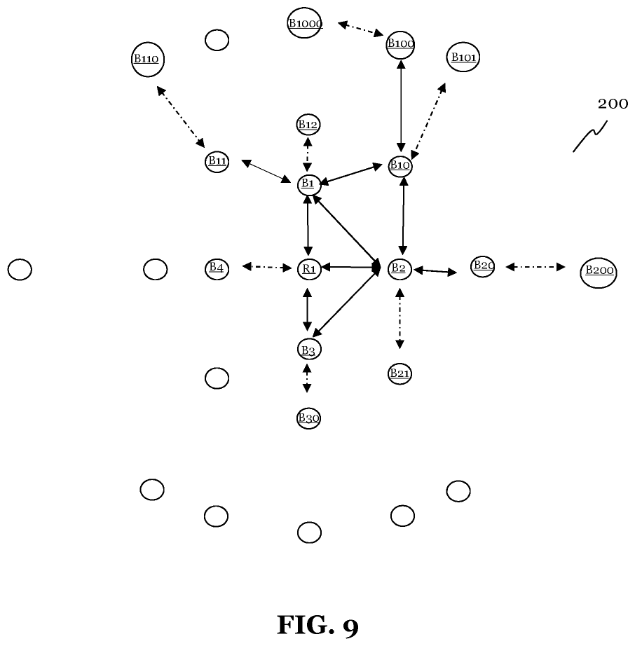

FIG. 9 depicts simultaneous provisioning of eight additional nodes into a node network in accordance with parallel provisioning of an embodiment.

The growth potential of a parallel provisioning of the node network 200 is further demonstrated in FIG. 9. With more nodes in the node network 200, more nodes can be simultaneously provisioned into the node network. Each of the eight nodes of the node network 200 may provision additional nodes. This allows eight new nodes to be provisioned into the network simultaneously. In various embodiments, one, some or all, of the nodes may be movable.

In various embodiments less than all of the nodes of a node network 200 may be configured to provision additional nodes. A node network 200 may be provisioned in parallel as long as more than one of the nodes is configured to provision additional nodes.

As the nodes are provisioned into the node network 200, they may be assigned addresses. As referenced earlier, assigning an address to the nodes of a node network allows messages to be transmitted from one node of a node network 200 to another node of a node network with instructions intended for a specific node. This may allow task discrimination among the nodes of a network.

For example, a node network 200 may comprise a plurality of smart lights as nodes. An instruction may be generated to dim one of the plurality of smart lights. Using an address associated with the target smart light, a message may be delivered through the node network 200 (node to node) until arriving at the target node, which can respond accordingly.

Referring back to FIG. 1, for example, an instruction addressed for a twenty-third node A23 can be relayed from the root node R1 via the first node A1 and to the twelfth node A12. But, only the target node (in this example the twenty-third node A23) will respond to the instruction because of the addressing. As will be appreciated, the instructions may be relayed from the root node to the twenty-third A23 along other routes.

Reliable addressing may thus be beneficial for a node network. A node network that assigns the same address to more than one node may create confusion in the network. Instructions may be carried out by nodes other than the target node if more than one node has the same address. Or, instructions may not be delivered to the appropriate node.

A node network may have a finite number of addresses available for assignment to nodes. As will be appreciated, the number of addresses may vary from embodiment to embodiment. This number of addresses may be predetermined before a network is provisioned. The number of addresses provisioned is a matter of configuration and can vary from embodiment to embodiment. For Bluetooth® Low Energy networks, the number of nodes may be limited to 32,767. Node networks may be configured for more nodes and more addresses.

It may be beneficial to coordinate addressing of the nodes during simultaneous provisioning. This may be beneficial to remove the chance of duplicate addressing within the node network. Allocating ranges of addresses to nodes after provisioning can reduce or eliminate the likelihood that a node may be assigned a duplicate address.

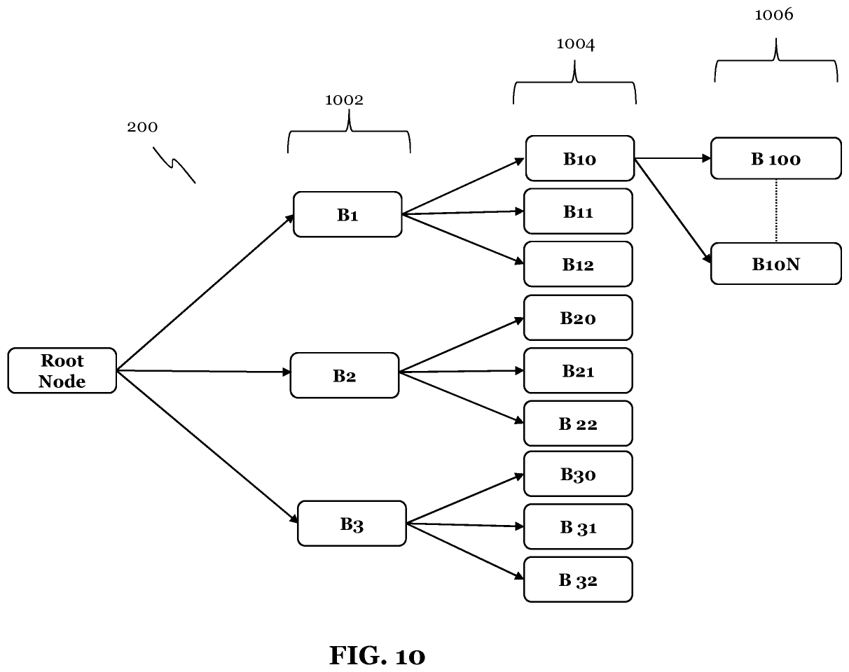

FIG. 10 depicts generational relationships of the nodes of a node network of an embodiment.

For explanatory purposes, a provisioning node will be referred to as a parent node. The provisioned node will be referred to as child nodes. Nodes that have the same parent node will be referred to as sibling nodes. For example, as depicted in FIG. 10, a root node R1 may provision a first node B1, a second node B2, and a third node B3. The root node R1 is thus the parent node of the first node B1, second node B2, and third node B3. The first node B1, second node B2, and third node B3 are sibling nodes.

A generation of nodes refers to all the children of a set of sibling nodes. For example, the root node R1 may not have sibling nodes, so the children of the root node R1 nodes may form a generation of nodes. Returning to FIG. 10, the first node B1, second node B2, and third node B3 form a first generation of nodes 1002.

The first node B1, the second node B2, and the third node B3 are sibling nodes. Together, the children of the sibling nodes form a generation. The children of the first node B1, second node B2, and third node B3 thus form a second generation of nodes 1004. The children of the nodes of the second generation of nodes 1004 form a third generation of nodes 1006. The root node R1 may provision a first generation of nodes 1002. The first generation of nodes 1002 may provision the second generation of nodes 1004 as some or all of the nodes of the first generation of nodes 1002 may provision additional nodes. The second generation of nodes 1004 may provision a third generation of nodes as some or all of the nodes of the second generation of nodes 1004 may provision additional nodes. The third generation of nodes 1006 may provision a fourth generation of nodes as some or all of the nodes of the third generation of nodes 1006 may provision additional nodes This may continue indefinitely. The number of generations present in a node network 200 may vary from embodiment to embodiment. And, the number of nodes in any given generation of nodes may vary from embodiment to embodiment.

The node network 200 in FIG. 10 may be provisioned in parallel. The root node R1 may provision the first node B1 and simultaneous provisioning of the remaining nodes may proceed from there in parallel. It should be noted that parallel provisioning may occur outside a generation. For example, in various embodiments a node from the first generation may be provisioned simultaneously with one or more nodes of the second generation or any other generation. The order of provisioning of the nodes into a node network may vary depending on the locations of the nodes (their proximity and density to other nodes) among other factors.

To reduce, or eliminate, the possibility that duplicate addresses are assigned to different nodes during the provisioning process ranges of addresses may be reserved for the nodes as the provisioning occurs. As will be appreciated ranges for nodes may be predetermined before provisioning occurs.

In various embodiments, the number of addresses available to the network may be divided into sets and reserved for nodes that are provisioned into the network and descendants of the nodes. In this context, the descendants of a node refer to the direct line descendants (children, children's children and so forth). Each node of a generation of nodes may be allocated a range of addresses for itself and its descendants when provisioned into a node network. The node and any descendant nodes of the node that are provisioned in the future may be assigned an address falling in the range. The sets may be disjoint.

For example, let it be assumed that 121 addresses are available to a node network 200 for assignment to the nodes of the network. The root node R1 may be assigned one of the addresses leaving 120 remaining addresses. A first set of addresses may be reserved for the first node B1 and all nodes descended from the first node B1. A second set of addresses may be reserved for the second node B2 and all nodes descended from the second node B2. A third set of addresses may be reserved for the third node and all nodes descended from the third node B3. In various embodiments, the sizes of the sets of addresses may be equal. For example, the first set may comprise 40 addresses, the second set may comprise 40 addresses, and the third set may comprise 40 addresses. However, in other embodiments, the sizes of the sets of addresses reserved for nodes and their children are not equal.

As new nodes are provisioned into the node network 200, allocation of the available addresses may also continue. The first node B1 may provision a node B10, a node B11, and a node B12. Node B10, and its descendants, may be allocated a subset of addresses drawn from the set of addresses allocated to node B1. Node B11, and its descendants, may be allocated a subset of addresses drawn from the set of addresses allocated to node B1. Node B12, and its descendants, may be allocated a subset of addresses drawn from the set of addresses allocated to node B1. Assuming the set of addresses allocated to node B1 comprises forty addresses, one address may be assigned to node B1, 13 addresses may be allocated for B10 and its descendants, 13 addresses may be allocated for B11 and its descendants, and 13 addresses may be allocated for B12 and its descendants. In various embodiments, the subsets may comprise equal number of addresses. The subsets may be disjoint. The children of the second node B2 may be allocated subsets in this manner from the addresses allocated to B2 and its descendants. The children of the third node B3 may be allocated subsets in this manner from the addresses allocated to B3 and its descendants. Children of any additional nodes of the first generation of nodes may also be allocated addresses in the same way.

In various embodiments, the root node R1 may reserve a number of available addresses for itself so that it does not exhaust the supply of addresses available when allocating addresses to other nodes. In various embodiments, children nodes may also reserve nodes for themselves from the set of addresses that they have been allocated. In various embodiments, the size of the sets of addresses allocated to children of the root node R1 may vary as more nodes are provisioned. For example, the first node (or each node of a first group of nodes), provisioned by a root node may be allocated a first number of addresses, and a second node (or each node of a second group of nodes) provisioned by the root node may be allocated a second number of addresses that is smaller than the number of addresses allocated to the first node.

In various embodiments, the children of the nodes of the second generation of nodes 1004 may also be allocated addresses for themselves and their descendants. For example, the node B10 may provision a node B100. The node B100 may be allocated a division of the subset of nodes allocated to B10. Additional nodes provisioned by B10 may be allocated additional divisions of the subset allocated to B10. In various embodiments, the divisions of the subset may be disjoint. In various embodiments, the divisions of the subset may be equal. In some embodiments where the subset of addresses allocated to B10 and its descendants includes thirteen addresses, each division of these subset may include 4 addresses. The other nodes of the third generation may also be allocated addresses for themselves and their descendants in this manner. Nodes of additional generations may also be allocated addresses for themselves and their descendants to prevent duplicative addressing. As will be appreciated, the number of generations of a network may be different in different embodiments.

In various embodiments, the order of the allocation of addresses may be predetermined based on the order of provisioning. In various embodiments, the nodes of a node network may be configured to provisions a predetermined number of other devices. For example, in various embodiments, each node may be configured to provision three nodes or less into a node network. As will be appreciated, in different embodiments, the number of nodes that may be provisioned by the nodes may be different. In various embodiments, each node may be configured to provision four nodes or less into a node network 200, five nodes or less, ten nodes or less, or any other number. Further, in various embodiments a node network 200 may comprise a mix of nodes that are configured to provision different numbers of other nodes. Some nodes of a network may be configured to provision four nodes or less and some nodes may be configured to provision two nodes or less. As will be appreciated, the allocation of the addresses may be influenced by the number of nodes that may be provisioned by a newly provisioned node (a node that is configured to provision more devices may be allocated more addresses).

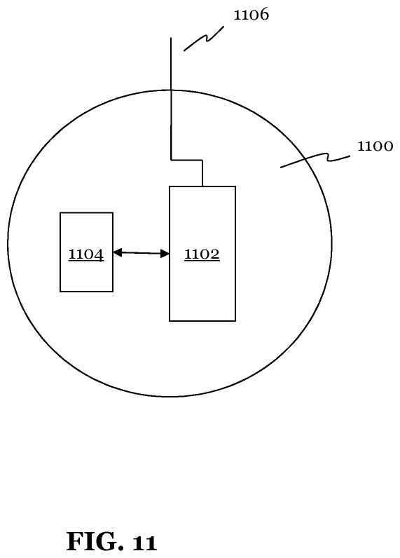

FIG. 11 depicts a node of a node network of an embodiment.

A node 1100 may comprise processing circuit and a memory 1104 such as a non-transitory computer readable storage medium. The processing circuitry 1102 may comprise a microcontroller, SoC, FPGA, DSP, ASIC or other device. The processing circuitry 1102 may be coupled with circuitry for wireless & wired communication 1106, which receives and transmits communications with other nodes or unprovisioned devices within a communication range of the node 1100. The node may comprise a Bluetooth® Low Energy node.

The memory 1104 may store a program for execution by the processing circuit to provision a first child node of the node 1100 into a node network 200 and allocate a first set of addresses from a group of available addresses to the first child and descendants of the first child node and provision a second first child node of the node 1100 into the node network and allocate a second set of addresses from a group of available addresses to the second child and descendants of the second child node.

The program, when executed, may also cause the processing circuit to provision additional children into the node network 200 and allocate additional sets of addresses to the children and their descendants. The number of children of the node 1100 may be limited by the program. The number of addresses allocated to the children of the node 1100 may be determined from the number of addresses originally available to the node 1100 and the number of children that the node is configured to provision. For example, if 120 addresses are available to the node, and it is configured to provision three children, each child node may be allocated 40 nodes. However, it should be noted that the number of nodes allocated to each child need not be equal.

The node 1100 may comprise a root node. For a root node, the group of available addresses may comprise the addresses available to the network. This number may vary from embodiment to embodiment. In some embodiments, the number of addresses available may be 32,767. The node 1100 may comprise a child of a parent node. In various embodiments where the node 1100 comprises a child node, the group of addresses available to the node 1100 may comprise a set of addresses allocated to the node 1100 by its parent node for the node 1100 and its descendants. As will be appreciated, the size may vary depending on the number of addresses available to the network for nodes, when the node 1100 was provisioned into the network among other factors. In various embodiments, each node of a node network 200 may comprise a node 1100.

In various embodiments, the memory 1104 may store data indicating the addresses allocated to children of the node 1100 so that the addresses are not allocated more to more than one child node.

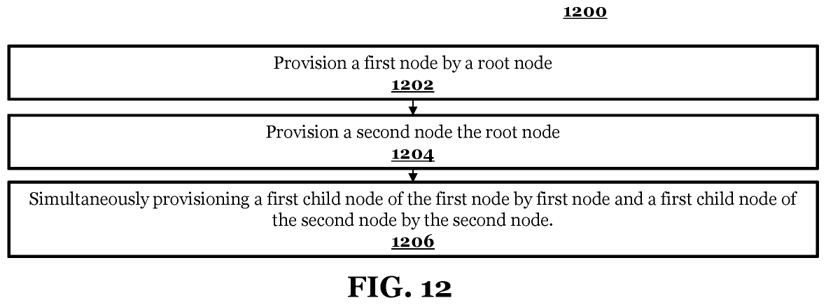

FIG. 12 illustrates a method 1200 to provision a node network in accordance with an embodiment.

The method 1200 may comprise, at a step 1202, provisioning a first node by a root node; at a step 1204, provisioning a second node by the root node; and at a step 1206, simultaneously provisioning a first child node of the first node by first node and a first child node of the second node by the second node.

In various embodiments, the method 1200 further comprises provisioning a third node by the root node.

In various embodiments, the method 1200 further comprises provisioning by the third node a first child node of the third node.

In various embodiments, the method 1200 further comprises wherein the first child node of the third node is simultaneously provisioned with the first child node of the first node and the first child node of the second node.

In various embodiments, the method 1200 further comprises allocating a first set of addresses for the first node and all nodes descended from the first node.

In various embodiments, the method 1200 further comprises allocating a second set of addresses for the second node and all nodes descended from the second node, the second set of addresses and the first set of addresses being disjoint.

In various embodiments, the method 1200 further comprises allocating a first subset of the first set of addresses to the first child node of the first node and all nodes descended from the first child node of the first node.

In various embodiments, the method 1200 further comprises allocating a first subset of the second set of addresses to the first child node of the second node and all nodes descended from the first child node of the second node.

In various embodiments, the method 1200 further comprises provisioning by the first node a second child node of the first node.

In various embodiments, the method 1200 further comprises allocating a second subset of the first set of addresses to the second child node of the first node and all nodes descended from the second child node of the first node, the first subset of the first set of addresses and the second subset of the first set of addresses being disjoint.

In various embodiments, the method 1200 further comprises provisioning by the second node a second child node of the second node.

In various embodiments, the method 1200 further comprises allocating a second subset of the second set of addresses to the second child node of the second node and all nodes descended from the second child node of the second node, the first subset of the second set of addresses and the second subset of the second set of addresses being disjoint.

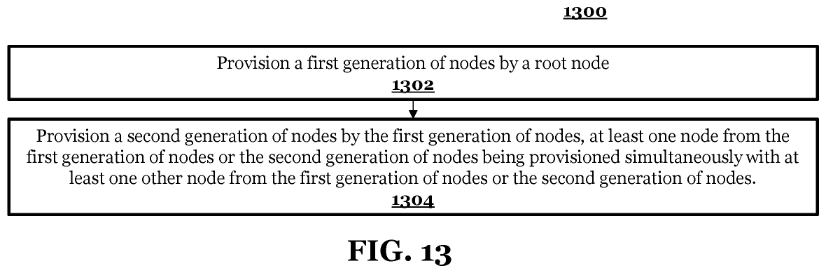

FIG. 13 illustrates a method 1300 to provision a node network in accordance with an embodiment.

In various embodiments, the method 1300 comprises, at a step 1302 provisioning a first generation of nodes by a root node; and, at a step 1304 provisioning a second generation of nodes by the first generation of nodes, at least one node from the first generation of nodes or the second generation of nodes being provisioned simultaneously with at least one other node from the first generation of nodes or the second generation of nodes.

In various embodiments, the method 1300 further comprises allocating a disjoint set of addresses for each node of the first generation of nodes and descendants of that node.

In various embodiments, the method 1300 further comprises assigning an address to each node of the node network based on the allocation of addresses.

In various embodiments, the method 1300 further comprises provisioning a third generation of nodes by the second generation of nodes.

In various embodiments, the method 1300 further comprises wherein at least two nodes of the third generation of nodes are provisioned simultaneously.

In various embodiments, the method 1300 further comprises allocating a disjoint set of addresses for each node of the first generation of nodes and descendants of that node.

In various embodiments, the method 1300 further comprises dividing the disjoint sets into further disjoint subsets, each disjoint subset being allocated to a node of the second generation of nodes and descendants of that node.

Example 1. A method to provision a node network, the method including: provisioning a first node by a root node; provisioning a second node by the root node; and simultaneously provisioning a first child node of the first node by first node and a first child node of the second node by the second node.

Example 2. The method of Example 1, further including provisioning a third node by the root node.

Example 3. The method of Example 1 or Example 2, further including provisioning, by the third node, a first child node of the third node.

Example 4. The methods of Examples 1 to 3, further including wherein the first child node of the third node is simultaneously provisioned with the first child node of the first node and the first child node of the second node.

Example 5. The methods of Examples 1 to 4, further including allocating a first set of addresses for the first node and all nodes descended from the first node.

Example 6. The methods of Examples 1 to 5, further including allocating a second set of addresses for the second node and all nodes descended from the second node, the second set of addresses and the first set of addresses being disjoint.

Example 7. The methods of Examples 1 to 6, further including allocating a first subset of the first set of addresses to the first child node of the first node and all nodes descended from the first child node of the first node.

Example 8. The methods of Examples 1 to 7, further including allocating a first subset of the second set of addresses to the first child node of the second node and all nodes descended from the first child node of the second node.

Example 9. The methods of Examples 1 to 8, further including provisioning by the first node a second child node of the first node.

Example 10. The methods of Examples 1 to 9, further including allocating a second subset of the first set of addresses to the second child node of the first node and all nodes descended from the second child node of the first node, the first subset of the first set of addresses and the second subset of the first set of addresses being disjoint.

Example 11. The methods of Examples 1 to 10, further including provisioning, by the second node, a second child node of the second node.

Example 12. The methods of Examples 1 to 11, further including allocating a second subset of the second set of addresses to the second child node of the second node and all nodes descended from the second child node of the second node, the first subset of the second set of addresses and the second subset of the second set of addresses being disjoint.

Example 13. A method to provision a node network including: provisioning a first generation of nodes by a root node; and provisioning a second generation of nodes by the first generation of nodes, at least one node from the first generation of nodes or the second generation of nodes being provisioned simultaneously with at least one other node from the first generation of nodes or the second generation of nodes.

Example 14. The method of Examples 13, further including allocating a disjoint set of addresses for each node of the first generation of nodes and descendants of that node.

Example 15. The method of Examples 13 or 14, further including assigning an address to each node of the node network based on the allocation of addresses.

Example 16. The method of Examples 13 to 15, further including provisioning a third generation of nodes by the second generation of nodes.

Example 17. The method of Examples 13 to 16, further including wherein at least two nodes of the third generation of nodes are provisioned simultaneously.

Example 18. The method of Examples 13 to 17, further including allocating a disjoint set of addresses for each node of the first generation of nodes and descendants of that node.

Example 19. The method of Examples 13 to 18, further including dividing the disjoint sets into further disjoint subsets, each disjoint subset being allocated to a node of the second generation of nodes and descendants of that node.

Example 20. A node of a node network, the node including: a processing circuit; and a non-transitory computer readable storage medium storing a program for execution by the processing circuit that causes the node to provision a first child node into the node network and allocate a first set of addresses from a group of available addresses to the first child node and descendants of the first child node, and provision a second child node into the node network and allocate a second set of addresses from the group of available addresses to the second child node and descendants of the second child node, the first set of addresses and the second set of addresses being disjoint.

Example 21. The node of Example 20, wherein the node is a root node and the group of available addresses includes all addresses for nodes available to the node network.

Example 22. The node of claim 20 or 21, wherein the node is a child node and the group of available addresses includes addresses allocated by a parent node of the node for the node and its descendants.

Example 23. The node of Example 20 to 22, wherein the non-transitory computer readable storage medium is configured to store data indicating which addresses make up the first set of addresses and which addresses make up the second set of addresses.

Example 24. The node of Example 20 to 23, wherein the node network includes a mesh network.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for parallel provisioning of a node network, the method comprising:
provisioning a first node by a root node;
provisioning a second node by the root node; and
simultaneously provisioning a first child node of the first node by first node and a first child node of the second node by the second node.

2. The method of claim 1, further comprising provisioning a third node by the root node.

3. The method of claim 2, further comprising provisioning, by the third node, a first child node of the third node.

4. The method of claim 3, wherein the first child node of the third node is simultaneously provisioned with the first child node of the first node and the first child node of the second node.

5. The method of claim 1, further comprising allocating a first set of addresses for the first node and all nodes descended from the first node.

6. The method of claim 5, further comprising allocating a second set of addresses for the second node and all nodes descended from the second node, the second set of addresses and the first set of addresses being disjoint.

7. The method of claim 6, further comprising allocating a first subset of the first set of addresses to the first child node of the first node and all nodes descended from the first child node of the first node.

8. The method of claim 7, further comprising allocating a first subset of the second set of addresses to the first child node of the second node and all nodes descended from the first child node of the second node.

9. The method of claim 8, further comprising provisioning, by the first node, a second child node of the first node.

10. The method of claim 9, further comprising allocating a second subset of the first set of addresses to the second child node of the first node and all nodes descended from the second child node of the first node, the first subset of the first set of addresses and the second subset of the first set of addresses being disjoint.

11. The method of claim 10, further comprising provisioning, by the second node, a second child node of the second node.

12. The method of claim 11, further comprising allocating a second subset of the second set of addresses to the second child node of the second node and all nodes descended from the second child node of the second node, the first subset of the second set of addresses and the second subset of the second set of addresses being disjoint.

13. A method for parallel provisioning of a node network comprising:
provisioning a first generation of nodes by a root node; and
provisioning a second generation of nodes by the first generation of nodes, at least one node from the first generation of nodes or the second generation of nodes being provisioned simultaneously with at least one other node from the first generation of nodes or the second generation of nodes.

14. The method of claim 13, further comprising allocating a disjoint set of addresses for each node of the first generation of nodes and descendants of that node.

15. The method of claim 14, further comprising assigning an address to each node of the node network based on the allocation of addresses.

16. The method of claim 13, further comprising provisioning a third generation of nodes by the second generation of nodes.

17. The method of claim 16, wherein at least two nodes of the third generation of nodes are provisioned simultaneously.

18. The method of claim 13, further comprising allocating a disjoint set of addresses for each node of the first generation of nodes and descendants of that node.

19. The method of claim 18, further comprising dividing the disjoint sets into further disjoint subsets, each disjoint subset being allocated to a node of the second generation of nodes and descendants of that node.

20. A node of a node network, the node comprising:
a processing circuit; and
a non-transitory computer readable storage medium storing a program for execution by the processing circuit that causes the node to provision a first child node into the node network and allocate a first set of addresses from a group of available addresses to the first child node and descendants of the first child node, and provision a second child node into the node network and allocate a second set of addresses from the group of available addresses to the second child node and descendants of the second child node, the first set of addresses and the second set of addresses being disjoint.

21. The node of claim 20, wherein the node is a root node and the group of available addresses comprises all addresses for nodes available to the node network.

22. The node of claim 20, wherein the node is a child node and the group of available addresses comprises addresses allocated by a parent node of the node for the node and its descendants.

23. The node of claim 20, wherein the non-transitory computer readable storage medium is configured to store data indicating which addresses make up the first set of addresses and which addresses make up the second set of addresses.

24. The node of claim 20, wherein the node network comprises a mesh network.
